(19) United States
(12) Patent Application Publication
(10) Pub. No.: US 2026/0180899 A1
(43) Pub. Date: Jun. 25, 2026

(54) MESSAGE PRIORITIZATION FOR RESOURCE RESERVATION PROTOCOL (RSVP)

(71) Applicant: Arista Networks, Inc., Santa Clara, CA (US)

(72) Inventors: Quintin Alexander Smith, Burnaby (CA); Paul Jacob Miiller, Burnaby (CA); Jeffrey Christopher Hornsberger, Vancouver (CA)

(21) Appl. No.: 18/988,383

(22) Filed: Dec. 19, 2024

(51) Int. Cl. H04L 45/50; H04L 47/6275; H04L 47/724

(52) U.S. Cl. CPC H04L 45/50; H04L 47/6275; H04L 47/724

(57) ABSTRACT

A method of operating a network device is provided that includes receiving a message, determining whether the message is associated with a known label-switched path (LSP), enqueuing the message in a first queue on the network device in response to determining that the message is associated with a known label-switched path, and enqueuing the message in a second queue, different than the first queue, on the network device subsequent to determining that the message is associated with an unknown label-switched path. The method can further include determining whether there are any messages associated with a known label-switched path enqueued in the first queue and continuously processing messages associated with the known label-switched path before either a message is dequeued from the second queue or the program yields to allow other pending workloads or processes to run.

### BACKGROUND

A communication system can include multiple network devices that are interconnected to form a network for conveying packets from a source device to a destination device. Network devices within a network can be configured to communicate with one another in accordance with a Resource Reservation Protocol (RSVP). RSVP can be employed to reserve resources for specific data flows, ensuring that they receive the necessary bandwidth while maintaining low latency.

In large-scale networks, RSVP routers can sometimes receive tens of thousands of control plane messages in a relatively short amount of time and can be asked to bring up tens of thousands of new Label-Switched Paths (LSPs) in a short amount of time. In such scenarios, the network devices can spend too much time processing the new LSPs but not enough time maintaining existing LSPs, which can result in packet loss, slow convergence times, and traffic disruption. It is within such context that the embodiments herein arise.

### BRIEF DESCRIPTION OF THE DRAWINGS

FIG. 1 is a diagram of an illustrative system having one or more network devices in accordance with some embodiments.

FIG. 2 is a diagram of an illustrative Label-Switched Path (LSP) in accordance with some embodiments.

FIG. 3 is a flowchart of illustrative steps for processing an incoming message in accordance with some embodiments.

FIG. 4 is a flowchart of illustrative steps for returning a next message to be processed in accordance with some embodiments.

FIG. 5 is a flowchart of illustrative steps for processing a returned message in accordance with some embodiments.

FIG. 6 is a diagram showing illustrative hardware components within a data processing system in accordance with some embodiments.

### DETAILED DESCRIPTION

A network device such as a switch or router may receive control packets from one or more neighboring network devices. The network device can include one or more processors, including a packet processor and a central processing unit (CPU) configured to handle network packets in accordance with a Resource Reservation Protocol (RSVP), as defined by one or more of Request for Comments (RFCs) such as RFC 2205 (and also RFC 3209). In particular, methods of handling RSVP messages are provided. For messages associated with a known Label-Switched Path (LSP), those messages can be enqueued in a high priority queue. For messages associated with an unknown LSP, only Path messages will be enqueued in a separate low priority queue while all other types of messages are dropped. The newly received Path message can replace any formerly received Path messages associated with that unknown LSP, thus only keeping a record of the latest Path message. Such selective dropping of messages allows the network device to avoid dropping the most important messages while preventing wasting time on stale information. Operating a network in this way can be technically advantageous and beneficial to speed up convergence time while reducing traffic loss due to refresh timeouts.

When processing RSVP messages, the network device can process queued messages associated with unknown LSPs only if the network device has already finished processing all queued messages associated with known LSPs. In other words, the network device will only dequeue messages from the low priority queue after it has finished processing all messages from the high priority queue. Prioritizing messages from the high priority queue over messages from the low priority queue allows the control plane to dynamically scale up when it has the resources to do so and to avoid introducing additional workload when it is busy handling existing LSPs. Operating a network in this way is technically advantageous and beneficial to keep existing LSPs functional while avoiding timeouts even during heavy churn. Moreover, new LSPs being brought up are also more likely to succeed while avoiding wasting resources in that network device and downstream nodes, which can help increase convergence times in the network as a whole. Messages associated with unknown LSPs can also be handled one at a time.

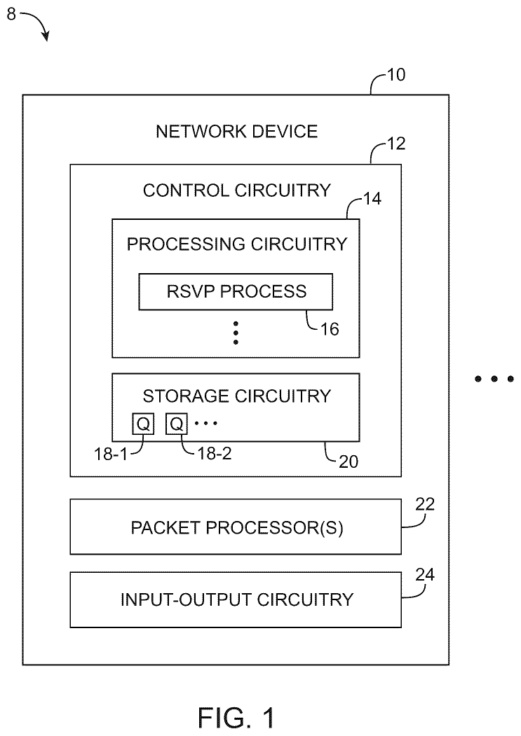

An illustrative networking system configured to provide such improvements to RSVP is shown in FIG. 1. As shown in FIG. 1, networking system 8 may include one or more network devices 10. Each network device 10 in system 8 may be a switch (e.g., a multi-layer L2/L3 switch), a router or gateway, a bridge, a hub, a repeater, a firewall, a wireless access point, a device serving other networking functions, a device that includes a combination of these functions, or other types of network devices. Multiple such network devices having the same or different networking functions in system 8 may be present and interconnected to form a communications network that processes and/or forwards traffic (e.g., data and control packets) between end hosts.

The communications network may be implemented with any suitable scope (e.g., as a wide area network, including one or more campus area networks or including one or more local area networks, etc.). If desired, the communications network may include internet service provider networks (e.g., the Internet) or other public service provider networks, private service provider networks (e.g., multiprotocol label switching (MPLS) networks), and/or may include other types of networks such as telecommunication service provider networks (e.g., a long-term evolution (LTE) network).

As shown in FIG. 1, network device 10 may include control circuitry 12, one or more packet processor(s) 22, and input-output circuitry 24 disposed within a housing of network device 10. Control circuitry 12 may include processing circuitry 14 and storage circuitry 20 and is thus sometimes referred to collectively as storage and processing circuitry. The housing of network device 10 may include an exterior cover (e.g., a plastic exterior shell, a metal exterior shell, or an exterior shell formed from other rigid or semirigid materials) that provides structural support and protection for the components of network device 10 disposed within the housing.

Processing circuitry 14 may include one or more processors or processing units based on central processing units (CPUs), graphics processing units (GPUs), microprocessors, general-purpose processors, host processors, microcontrollers, digital signal processors, programmable logic devices such as a field programmable gate array device (FPGA), application specific system processors (ASSPs), application specific integrated circuit (ASIC) processors, and/or other types of processors. Processing circuitry 14 may run (execute) a network device operating system and/or other software/firmware that is stored on storage circuitry 20.

Storage circuitry 20 may include non-transitory (tangible) computer readable storage media configured to store the operating system software and/or any other software code, sometimes referred to as program instructions, software, data, instructions, or code. As an example, the operations described herein for selectively delaying routes as well as other network device data plane functions may be stored as (software) instructions on the non-transitory computer-readable storage media (e.g., in portion(s) of storage circuitry 20 in network device 10). The corresponding processing circuitry (e.g., one or more processors of processing circuitry 14 in network device 10) may process or execute the respective instructions to perform the corresponding operations. Storage circuitry 20 may be implemented using non-volatile memory (e.g., flash memory or other electrically-programmable read-only memory configured to form a solid-state drive), volatile memory (e.g., static or dynamic random-access memory), hard disk drive storage, and/or other storage circuitry. Storage circuitry 20 is therefore sometimes referred to as memory circuitry. Processing circuitry 14 and memory circuitry 20 as described above may sometimes be referred to collectively as control circuitry 12 implementing a “control plane” of network device 10.

In particular, processing circuitry 14 may execute control plane software such as operating system software, routing policy management software, routing protocol agents or processes (e.g., Resource Reservation Protocol or “RSVP” processes such as an active RSVP process 16, one or more Border Gateway Protocol or “BGP” processes, one or more Link Aggregation Control Protocol or “LACP” processes, etc.), and other software, may be used to support the operation of protocol clients and/or servers, may be used to support the operation of packet processor(s) 22, may store packet forwarding information, may execute packet processing software, and/or may execute other software instructions that control the functions of network device 10 and the other components therein.

While processing circuitry 14 is shown in FIG. 1 as executing one or more RSVP processes 16, processing circuitry 14 may also execute one or more other network routing protocol agents or processes. As examples, any network processes such as network protocol agents may implement the Spanning Tree Protocol (STP), Multiple Spanning Tree Protocol (MSTP), Open Shortest Path First (OSPF) protocol, Enhanced Interior Gateway Routing Protocol (EIGRP), Virtual Router Redundancy Protocol (VRRP), Hot Standby Router Protocol (HSRP), VLAN Trunking Protocol (VTP), Intermediate System to Intermediate System (IS-IS) protocol, Virtual Extensible LAN (VXLAN) protocol, Bidirectional Forwarding Detection (BFD) protocol, Address Resolution Protocol (ARP), Internet Group Management Protocol (IGMP), non-BGP distance vector routing protocols, Protocol Independent Multicast (PIM) protocols, Resource Reservation Protocol (RSVP), Link Layer Discovery Protocol (LLDP), Two-Way Active Measurement Protocol (TWAMP), Precision Time Protocol (PTP), Connectivity Fault Management (CFM) protocol, Exterior Gateway Protocol (EGP), Routing Information Protocol (RIP), Label Distribution Protocol (LDP), Multiprotocol Label Switching (MPLS), and/or other Internet routing protocols (just to name a few).

Packet processor(s) 22 may be used to implement a data plane or forwarding plane of network device 10. Packet processor(s) 22 may include one or more processors or processing units based on central processing units (CPUs), graphics processing units (GPUs), microprocessors, general-purpose processors, host processors, microcontrollers, digital signal processors, programmable logic devices such as a field programmable gate array device (FPGA), application specific system processors (ASSPs), application specific integrated circuit (ASIC) processors, and/or other processor architectures.

Packet processor 22 may receive incoming packets via input-output circuitry 24 (e.g., ports), parse and analyze the received packets, process the packets based on packet forwarding decision data (e.g., in a forwarding information base) and/or in accordance with a network protocol, and forward (or drop) the packet accordingly. The packet forwarding decision data may be stored on a portion of memory circuitry 20 and/or other storage circuitry integrated as part of or separate from packet processor 22. Input-output circuitry 24 may include communication interface components such as one or more Bluetooth interface, Wi-Fi interface, Ethernet interface, optical interface, and/or other wired or wireless network interfaces for connecting network device 10 to the Internet, a local area network, a wide area network, a mobile network, other types of networks, and/or to another network device, peripheral devices, and/or other electronic equipment. Network device 10 may also include other components such as a system bus or connector(s) that couple the components of network device 10 to one another, power management components, thermal management components, etc.

Network devices 10 within network 8 can be configured to communicate with one another in accordance with the Resource Reservation Protocol or “RSVP,” sometimes referred to herein as the RSVP protocol. The Resource Reservation Protocol is a signaling protocol designed to handle resource/bandwidth allocation and traffic engineering across a Multiprotocol Label Switching (MPLS) network. In an MPLS network that uses RSVP for signaling, a Label-Switched Path (LSP) can refer and be defined herein as a predetermined path through the network that data packets traverse from a source node to a destination node based on labels rather than conventional IP routing. Label-switched paths signaled using RSVP require periodic refreshes to maintain their state on the network, so RSVP-signaled LSPs can sometimes be referred to herein as “label-based” paths or “refreshable” paths.

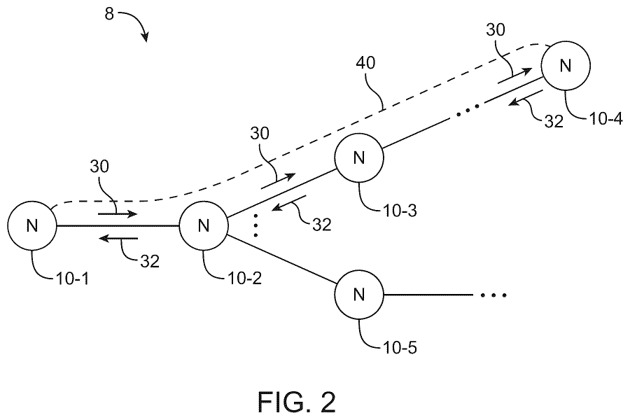

FIG. 2 is a diagram of an illustrative Label-Switched Path (LSP) such as LSP 40 in accordance with some embodiments. As shown in FIG. 2, network 8 can include one or more network devices such as network devices 10-1, 10-2, 10-3, 10-4, 10-5, etc. In the example of FIG. 2, network device 10-1 can be communicatively coupled to network device 10-2. Network device 10-2 can further be communicatively coupled to network devices 10-3 and 10-5. Network 10-3 can further be communicatively coupled to network device 10-4 via one or more intervening network devices. Network 8 can optionally further include one or more other network devices 10 not explicitly shown in FIG. 2 to avoid obscuring the present embodiment.

When a new LSP is needed, an RSVP process starts by sending a Path message from a head (source) node towards a destination (tail) node. In the exemplary arrangement of FIG. 2, consider network device 10-1 as being the head node and network device 10-4 as being the tail node, thus resulting in an LSP 40 coupling head node 10-1 to tail node 10-4. The head node is sometimes referred to as the “headend,” whereas the tail node is sometimes referred to as the “tailend.” The example of FIG. 2 in which head node 10-1 is coupled to the tail node 10-4 via two or more intervening nodes is merely illustrative. In general, a head node can be coupled to a tail node via zero or more intervening (intermediate) nodes.

Each node along an LSP can examine the received Path message and then forward the Path message toward the destination node while gathering (recording) network resource information from the Path message. A “Path message” can refer to and be defined (by RFC 2205) as a message that is output by a sender to establish a path state in the network by identifying a route through which data will travel and providing the necessary information about the data flow's characteristics. The Path message can also convey the sender's information (e.g., by describing the sender's IP address and port number), the sender's traffic characteristics (e.g., by specifying traffic parameters such as token bucket rate, bucket size, and peak rate so that devices along the LSP can allocate the appropriate amount of resources), network properties such as the available bandwidth, and/or other types of information. In the example of FIG. 2, head node 10-1 can send a Path message towards the tail node 10-4, as shown by the direction of arrows 30 along LSP 40.

When the Path message reaches tail node 10-4, the tail node sends an RSVP Reservation message back toward the head node 10-1 to confirm or acknowledge the reservation of resources along LSP 40. A “Reservation message” can refer to and be defined (by RFC 2205) as a message that is output by a receiving node to establish or update a resource reservation along an LSP established by a preceding Path message. The Reservation message can optionally contain various Quality of Service (QoS) information such as bandwidth and latency constraints to be enforced along an LSP, the destination IP address and protocol identifier for ensuring that the reservation is applied to the correct data flow, information specifying the type of resource reservation, and/or other types of information. In the example of FIG. 2, tail node 10-4 can send a Reservation message back towards the head node 10-1, as shown by the direction of arrows 32 along LSP 40.

As the Reservation message travels back along LSP 40 toward head node 10-1, each node along the LSP 40 can verify and reserve the required resources (e.g., bandwidth) to provide the requisite QoS requirements for data flows along LSP 40. Such method of operating network 8 enables the Resource Reservation Protocol to establish one or more LSPs 40 with guaranteed bandwidth, delay, or other QoS requirements. LSP reservations have to be periodically refreshed by RSVP messages, sometimes referred to herein as “refresh” messages, to maintain a particular LSP. A “refresh message” can refer to and be defined herein as a Path or Reservation message that has previously been seen by devices 10 of network 8.

Lastly, if LSP 40 is no longer needed, the head node 10-1 can send a PathTear message to a next hop in the LSP. The PathTear message is successively forwarded from one node to the next along LSP 40 to release the reserved resources, thus terminating the current LSP session. A “PathTear message” can refer to and be defined (by RFC 2205) as a message that is output by a sender to remove path state information from network devices along a specific LSP, thus freeing up or preventing unnecessary maintenance of expired or unused path resources. Other types of RSVP messages as defined by RFC 2205 can include Reservation Tear messages (e.g., messages for removing reservation state information for a specific data flow), Path Error messages (e.g., messages for reporting errors relating to Path messages), Reservation Error messages (e.g., messages for reporting errors relating to Reservation messages), and Hello messages (e.g., messages for maintaining RSVP neighbor relationships and for detecting control plane communication failures).

At scale, the Resource Reservation Protocol can sometimes receive tens of thousands of messages in a short period of time and can be employed to bring up thousands of new LSPs at the same time. Such scenarios can result in packet loss, slow convergence times, and even traffic disruption if a network device spends too much time processing new LSPs and not enough time refreshing existing LSPs.

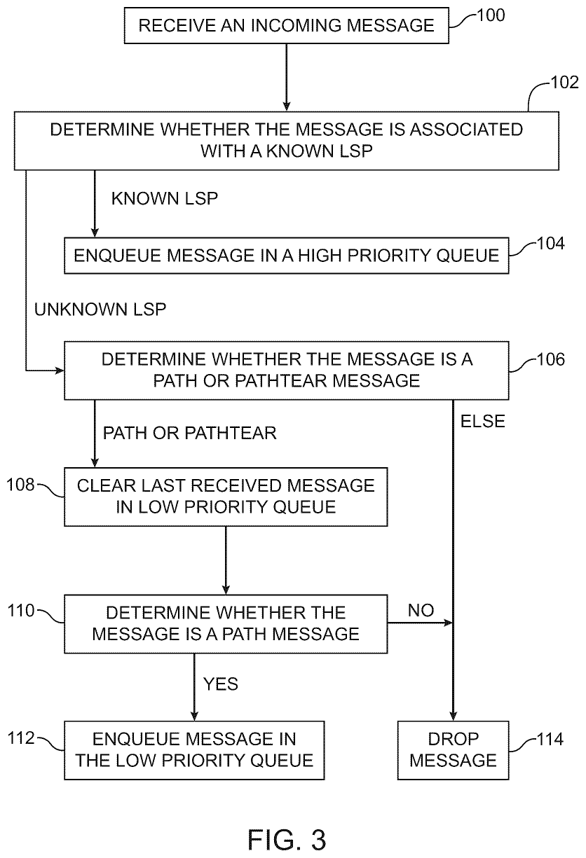

In accordance with some embodiments, methods for handling RSVP messages are provided for addressing these challenges. FIG. 3 is a flowchart of illustrative steps for processing an incoming message. At least one or more steps shown in FIG. 3 can be performed by the RSVP process or agent 16 being executed on control circuitry 12 of FIG. 1. During the operations of block 100, a network device 10 can receive an incoming message.

During the operations of block 102, network device 10 can be configured to determine whether the received message is associated with a known LSP. An LSP can be considered to be “known” to a given node if that node already has the state information for that LSP. In other words, if a network node has previously seen and handled a Path message associated with a particular LSP, then that LSP would be considered a “known” LSP to that network node. Conversely, if a network node has neither seen nor handled a Path message associated with a particular LSP, then that LSP would be considered an “unknown” LSP to that node. In other words, an LSP is considered to be “unknown” to a given node if that node does not already have the state information of that LSP.

In response to determining that the received message is associated with a known LSP, that message can be enqueued in a high priority queue (see operations of block 104). The high priority queue can be one of multiple queues 18 within storage circuitry 20 of FIG. 1. In the example of FIG. 1, queue 18-1 can represent the high priority queue operable or permitted to store messages associated with known LSPs during the operations of block 104. RSVP messages stored in high priority queue 18-1 can sometimes be referred to herein as high priority messages.

In response to determining that the received message is associated with an unknown LSP, network device 10 can be configured to determine whether that message is a Path message or a PathTear message (see operations of block 106). For example, RSVP process 16 running on processing circuitry 14 in FIG. 1 can analyze the contents of the message to determine whether any given message is a Path or PathTear message. A Path message has an RSVP type field indicating that it is a “Path” message, whereas a PathTear message has an RSVP type field indicating that it is a “PathTear” message. If the message is not a Path or PathTear message, then that message can be dropped (see operations of block 114).

If the message is a Path or PathTear message, network device 10 can clear or delete the last received message (e.g., the most recently received message) for the unknown LSP in a low priority queue (see operations of block 108). If there is no prior message stored in the low priority queue for that unknown LSP, then the operations of block 108 can be skipped. The low priority queue can be one of multiple queues 18 within storage circuitry 20 of FIG. 1. In the example of FIG. 1, queue 18-2 can represent the low priority queue operable or permitted to store messages associated with unknown LSPs. The low priority queue can store at most one message for each unknown LSP. Path messages stored in low priority queue 18-2 can sometimes be referred to herein as low priority messages.

During the operations of block 110, network device 10 can be configured to determine whether the received message is a Path message. As described above, a Path message has an RSVP type field indicating that it is a “Path” message. If the message is not a Path message (i.e., if the message is a PathTear message), then the newly received PathTear message can be dropped (see operations of block 114). PathTear messages will clear the last received low priority messages for the unknown LSP that is queued since there is no point in handling Path messages to create an LSP that will be immediately teared down.

If the message is a Path message, processing can proceed to block 112. During the operations of block 112, the newly received Path message can be enqueued in the low priority queue. Removing the last received message for an unknown LSP from the low priority queue during block 108 and then storing the newly received Path message for that same unknown LSP during block 112 replaces an old message with the newer message, ensuring that there is only one Path message per LSP to be processed within the low priority queue (e.g., only keeping a record of the latest Path message). Operated in this way, the low priority queue can be configured to store messages associated with unknown LSPs, whereas the high priority queue can be configured to store messages associated with known LSPs. The low priority queue can store messages associated with multiple unknown LSPs but can store at most one message for each unknown LSP. Operating a network in this way can be technically advantageous and beneficial to speed up convergence time while reducing traffic loss due to refresh timeouts.

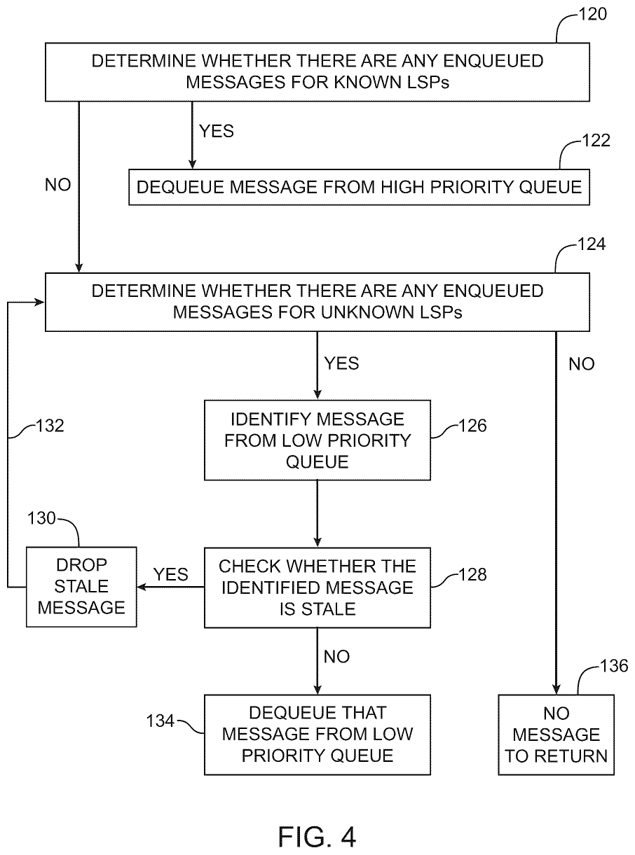

FIG. 4 is a flowchart of illustrative steps for returning a next message to be processed in accordance with some embodiments. At least one or more steps shown in FIG. 4 can be performed by the RSVP process or agent 16 being executed on control circuitry 12 of FIG. 1. During the operations of block 120, network device 10 can be configured to determine whether there are any enqueued messages for known LSPs. Since messages associated with known LSPs are stored in the high priority queue (e.g., queue 18-1 in FIG. 1), network device 10 can check whether the high priority queue is empty. If the high priority queue has one or more stored/enqueued messages, then network device 10 can dequeue a message from the high priority queue. A high priority message can be output from the high priority queue in a first-in first-out (FIFO) order. In other words, the oldest message can be first dequeued, whereas the newest message will be last to be dequeued from the high priority queue.

If there are no enqueued messages associated with known LSPs (e.g., if the high priority queue is empty), then processing may proceed to block 124. During the operations of block 124, network device 10 can be configured to determine whether there are any enqueued messages for unknown LSPs. Since messages associated with unknown LSPs are stored in the low priority queue (e.g., low priority queue 18-2 in FIG. 1), network device 10 can check whether the low priority queue is empty.

If the low priority queue has one or more stored/enqueued messages, then network device 10 can identify a message from the low priority queue (see operations of block 126). A low priority message can be output from the low priority queue in a first-in first-out (FIFO) order. In other words, the oldest message can be returned first, whereas the newest message will be last to be returned from the high priority queue. Thus, network device 10 may identify the oldest message in the low priority queue during the operations of block 126.

During the operations of block 128, network device 10 can check whether the message identified during block 126 is stale. A message may be considered “stale” if the message has been enqueued within the low priority queue for a period of time exceeding a threshold duration. For example, the threshold duration can be equal to 1 second, less than 1 second, more than 1 second, 1-2 seconds, 2-5 seconds, 5-10 seconds, or other suitable time period. In response to determining that the identified message is stale, the stale message can be dropped (see operations of block 130) and processing can loop back to block 124, as shown by path 132. Else, in response to determining that the identified message is not stale, that message can be dequeued from the low priority queue (see operations of block 134).

Dequeuing messages in this way can thus first return messages for known LSPs, considered to be high priority messages, in FIFO order to ensure that LSPs which are already up and running continue to stay active. Network device 10 only returns messages for unknown LSPs, considered to be low priority messages, only if there are no pending high priority messages. Since low priority messages in the low priority queue might be queued up for a while during high churn and high scale scenarios, low priority messages that have been queued up for too long (i.e., stale messages) can be dropped to avoid wasting processing time.

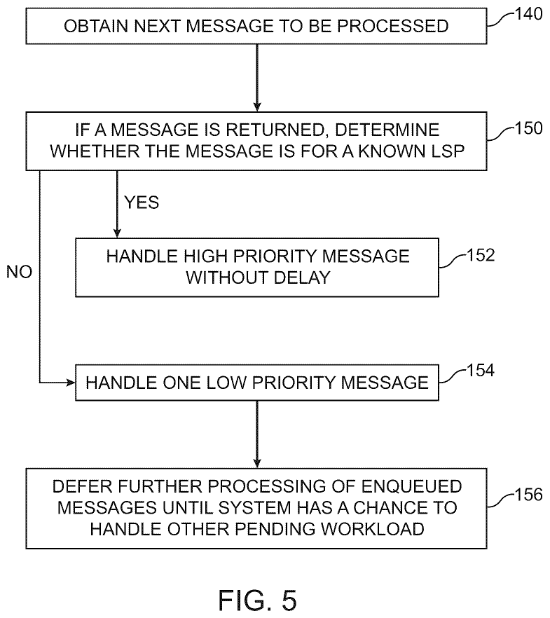

FIG. 5 is a flowchart of illustrative steps for processing a returned message in accordance with some embodiments. At least one or more steps shown in FIG. 5 can be performed by the RSVP process or agent 16 being executed on control circuitry 12 of FIG. 1. During the operations of block 140, network device 10 can be configured to obtain the next message to be processed. For example, RSVP process 16 can perform the operations described in connection with FIG. 4 to return a message from the high priority queue or a message from the low priority queue.

If a message is returned from the operations of FIG. 4, network device 10 can then determine whether the returned message is for a known LSP (see operations of block 150). If the returned message is for a known LSP (e.g., if the returned message is a high priority message output from the high priority queue), then that message can be immediately processed without delay (see operations of block 152). High priority messages can be continuously processed until either a low priority message is dequeued or until the program needs to yield to allow other workload(s) to be done (e.g., to run work from other processes or the same process). Else, if the returned message is for an unknown LSP (e.g., if the returned message is a low priority message output from the low priority queue), then processing can proceed to block 154.

During the operations of block 154, network device 10 can be configured to process only one (a single) low priority message at a time. After handling a low priority message, network device 10 can then defer further processing of enqueued messages until the overall system has had a chance to handle other pending workloads (see operations of block 156). Handling low priority messages one at a time ensures that creation of new LSPs are handled at a steady pace (e.g., dynamically bringing up more or less new LSPs depending on how busy the system is).

The operations of FIG. 5 thus process high priority messages continuously until either a low priority message is dequeued or until the program needs to yield to allow other workloads to run. The steps of FIG. 4 will only return a low priority message for processing when there are no other high priority messages enqueued. Prioritizing high priority messages for processing ensures that, at high scale, known LSPs are kept alive and new LSPs are only attempted to be brought up when the network has the resources necessary to handle them without affecting the known or existing LSPs. This allows the control plane to dynamically scale up when it has the resources to do so and to avoid introducing additional workload when it is busy handling existing LSPs. Operating a network in this way is technically advantageous and beneficial to keep existing LSPs functional while avoiding timeouts even during heavy churn.

Limiting the number of LSPs that network device 10 is allowed to bring up at a time also limits the number of LSPs that are not in Refresh Overhead Reduction (ROR), which is a scalability feature of RSVP that allows multiple LSPs to be refreshed in bulk without sending individual messages to refresh each LSP. Refreshing multiple LSPs in bulk restricts the signaling overhead at any point in time to a small and manageable amount even at high scale. Thus, an additional benefit of the above embodiments described in connection with FIGS. 1-5 is that by pacing the rate messages are being handled for unknown LSPs, such unknown LSPs can be more robustly established without overloading any given network device 10.

The operations of FIGS. 3-5 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

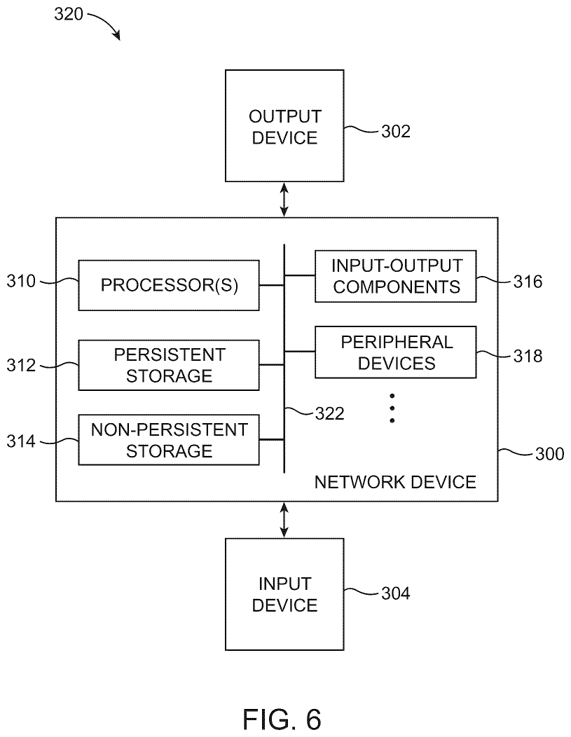

The foregoing embodiments may be made part of a larger system. FIG. 6 shows a system such as data processing system 320. Data processing system 320 may include a network device 300 optionally coupled to an input device 304 and/or an output device 302. Network device 300 may represent a network device 10 described in connection with the embodiments of FIGS. 1-5. Network device 300 may include one or more processors 310 (e.g., processing circuitry 14 of FIG. 1), storage circuitry such as persistent storage 312 (e.g., flash memory or other electrically-programmable read-only memory configured to form a solid-state drive, a hard disk drive, etc.), non-persistent storage 314 (e.g., volatile memory such as static or dynamic random-access memory, cache memory, etc.), or any suitable type of computer-readable media for storing data, software, program code, or instructions, input-output components 316 (e.g., communication interface components such as a Bluetooth® interface, a Wi-Fi® interface, an Ethernet interface, an optical interface, and/or other networking interfaces for connecting device 300 to the Internet, a local area network, a wide area network, a mobile network, other types of networks, and/or to another network device), peripheral devices 318, and/or other electronic components. These components can be coupled together via a system bus 322.

As an example, network device 300 can be part of a host device that is coupled to one or more output devices 302 and/or to one or more input devices 304. Input device(s) 304 may include one or more touchscreens, keyboards, mice, microphones, touchpads, electronic pens, joysticks, buttons, sensors, or any other type of input devices. Output device(s) 302 may include one or more displays, printers, speakers, status indicators, external storage, or any other type of output devices.

System 320 may be part of a digital system or a hybrid system that includes both digital and analog subsystems. System 320 may be used in a wide variety of applications as part of a larger computing system, which may include but is not limited to: a datacenter, a financial system, an e-commerce system, a web hosting system, a social media system, a healthcare/hospital system, a computer networking system, a data networking system, a digital signal processing system, an energy/utility management system, an industrial automation system, a supply chain management system, a customer relationship management system, a graphics processing system, a video processing system, a computer vision processing system, a cellular base station, a virtual reality or augmented reality system, a network functions virtualization platform, an artificial neural network, an autonomous driving system, a combination of at least some of these systems, and/or other suitable types of computing systems.

The methods and operations described above in connection with FIGS. 1-6 may be performed by the components of one or more network device(s) using software, firmware, and/or hardware (e.g., dedicated circuitry or hardware). Software code for performing these operations may be stored on non-transitory computer readable storage media (e.g., tangible computer readable storage media) stored on one or more of the components of the network device. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device (e.g., using processing circuitry 14 of FIG. 1).

The foregoing is merely illustrative and various modifications can be made to the described embodiments. The foregoing embodiments may be implemented individually or in any combination.

What is claimed is:

1. A method of operating a network device, comprising:
receiving a message;
determining whether the message is associated with a known label-switched path;
in response to determining that the message is associated with a known label-switched path, enqueuing the message in a first queue on the network device; and
subsequent to determining that the message is associated with an unknown label-switched path, enqueuing the message in a second queue, different than the first queue, on the network device.

2. The method of claim 1, further comprising:
in response to determining that the message is associated with an unknown label-switched path, determining whether the message is a Path message or a PathTear message.

3. The method of claim 2, further comprising:
in response to determining that the message is a Path message or a PathTear message and that the second queue has a last received message associated with the unknown label-switched path, deleting the last received message from the second queue; and
in response to determining that the message is neither a Path message nor a PathTear message, dropping the message.

4. The method of claim 3, further comprising:
in response to deleting the additional message from the second queue, determining whether the message is a Path message; and
in response to determining that the message is not a Path message but a PathTear message, dropping the PathTear message, wherein enqueuing the message in the second queue comprises enqueuing the message in the second queue in response to determining that the message is a Path message.

5. The method of claim 1, further comprising:
determining whether the first queue is empty;
in response to determining that the first queue is not empty, dequeuing a message from the first queue; and
in response to determining that the first queue is empty, determining whether the second queue is empty.

6. The method of claim 5, further comprising:
in response to determining that the second queue is not empty, identifying an oldest message in the second queue.

7. The method of claim 6, further comprising:
determining whether the oldest message is stale; and
in response to determining that the oldest message is stale, dropping the stale message.

8. The method of claim 7, further comprising:
in response to determining that the oldest message is not stale, dequeuing the oldest message from the second queue.

9. The method of claim 1, further comprising:
dequeuing one or more messages from the first queue; and
continuously processing the one or more messages dequeued from the first queue.

10. The method of claim 9, further comprising:
dequeue a message from the second queue; and
processing the message dequeued from the second queue and deferring further processing of messages from the second queue until the network device has an opportunity to handle other pending workload.

11. A method of operating a network device, comprising:
with a first queue, storing one or more messages associated with a known label-switched path;
with a second queue different than the first queue, storing one or more messages associated with an unknown label-switched path; and
determining whether there are any messages associated with a known label-switched path stored in the first queue.

12. The method of claim 11, further comprising:
in response to determining that there is at least one message associated with a known label-switched path stored in the first queue, dequeuing the at least one message from the first queue.

13. The method of claim 12, further comprising:
in response to determining that there are no messages associated with a known label-switched path stored in the first queue, determining whether there are any messages associated with an unknown label-switched path stored in the second queue.

14. The method of claim 13, further comprising:
in response to determining that there is at least one message associated with an unknown label-switched path stored in the second queue, identifying an oldest message from the second queue.

15. The method of claim 14, further comprising:
determining whether the oldest message is stale;
in response to determining that the oldest message is stale, dropping the stale message; and
in response to determining that the oldest message is not stale, dequeuing the oldest message from the second queue.

16. A method of operating a network device in accordance with a Resource Reservation Protocol (RSVP), the method comprising:
dequeuing a message from either a high priority queue or a low priority queue;
in response to dequeuing a message from the high priority queue, performing a first sequence of actions; and
in response to dequeuing a message from the low priority queue, performing a second sequence of actions different than the first sequence of actions.

17. The method of claim 16, further comprising:
with the high priority queue, permitting storing one or more messages associated with each known label-switched path; and
with the low priority queue, permitting storing at most one message for each unknown label-switched path.

18. The method of claim 17, wherein performing the first sequence of actions comprises continuously processing the one or more messages in the high priority queue without delay.

19. The method of claim 17, wherein performing the second sequence of actions comprises:
processing a single message dequeued from the low priority queue; and
in response to processing the single message from the low priority queue, deferring further processing of messages in the low priority queue until the network device has an opportunity to handle other pending workload.

20. The method of claim 16, further comprising:
receiving a message;
determining whether the received message is associated with a known label-switched path;
in response to determining that the received message is associated with a known label-switched path, enqueuing the received message in the high priority queue; and
subsequent to determining that the received message is not associated with a known label-switched path, enqueuing the message in the low priority queue.
